(19) United States
(12) Patent Application Publication
(10) Pub. No.: US 2014/0287387 A1
(43) Pub. Date: Sep. 25, 2014

(54) EMOTION RECOGNITION SYSTEM AND METHOD FOR ASSESSING, MONITORING, PREDICTING AND BROADCASTING A USER'S EMOTIVE STATE

(71) Applicant: EMOZIA, INC., Bronx, NY (US)

(72) Inventors: ALEKSANDAR VUKASINOVIC, Bronx, NY (US); Andrew Maxwell Fooden, Brooklyn, NY (US)

(73) Assignee: EMOZIA, INC., Bronx, NY (US)

(21) Appl. No.: 14/222,590

(22) Filed: Mar. 22, 2014

Related U.S. Application Data
(60) Provisional application No. 61/804,679, filed on Mar. 24, 2013.

(51) Int. Cl. G09B 7/02

(52) U.S. Cl. CPC G09B 7/02
USPC 434/236

(57) ABSTRACT

Systems and methods are provided for assessing, monitoring and predicting a person's emotive state based on the person's day-to-day social and physical activity, including biometric, geospatial and other data, and storing the emotive state in a form that can be used by others to enhance interaction with the person. Such interaction may be in the form of downloadable application, such as a video game, in which the play interaction is altered based upon the detected emotive state of the player.

### CORRESPONDING PATENT APPLICATION

The present application takes priority from provisional application Ser. No. 61/804,679 filed Mar. 24, 2013, the entire contents of which are incorporated herein in its entirety by reference.

### BACKGROUND

The present invention relates to a system and a method for assessing, monitoring and predicting an individual's emotive state based on the individual's level of physical and social activity, and then relaying the emotive state to self or others.

It is difficult generally for people to objectively assess their emotive states, and/or to accurately relay information about their emotive states to others. At the same time, many who have the resources maintain almost continuous electronic communication with others in one or more of various forms, whether by email, text-messaging, posts on social networks and blogs, and other mechanisms that cellular networks and Internet infrastructures provide. But there is often a correlation between a person's emotive state and how or when they electronically communicate with others. For example, the desire and readiness to participate in electronic communications depends on the person's emotive state. If, for example, a person normally replies to received emails fairly quickly under normal circumstances, but has not done so for a day or so recently, one might deduce that the person is either not feeling well, is stressed, is upset, or one of other possible emotive states. Of course there may be external factors unrelated to emotive states (for example, the person never saw the incoming email, or is so busy as to not have available time to respond).

Nonetheless, the correlation that often exists between a person's emotive state and their participating in communicating electronically with others is a valuable metric that service providers care about. The ability to assess the emotive state of a person and determine how that might correlate to providing a more enhanced electronic communication service can be very important. Of course, it would also be important if the identity of the emotive state permitted health providers and therapists to assist the person in improving his/her emotive state.

Neurological studies have shown that emotions, feelings and mood patterns are important elements in the human decision-making process. Yet most approaches for evaluating and monitoring emotive states are expensive and require specialized hardware. More problematic, however, is that they are often inaccurate. Recent developments in mobile device (e.g., smart phone) technologies offer a variety of functions and services (e.g., apps) directed toward assessing and/or transmitting the emotive state of the user. Some of them are based on applying known correlations between online activities and the emotive state of the individual, or trying to assess what the correlations are. Sensors and other data-collecting devices also exist to collect additional information about a person to discern the person's emotive state non-invasively.

An example is disclosed in US Patent Publ. 2013/0018837. One limitation is that it only relies on the content of the user's communications in determining the emotional level of the individual. Another is it lacks the mechanism offered by the present invention for dynamically adjusting the user's “baseline”. Moreover, the '837 publication does not offer any solutions for capturing deviations from the baseline. U.S. Pat. No. 8,285,257 describes a mobile communication terminal capable of transmitting, receiving and displaying the emotion data by way of a mobile device, but does not generate emotion data from the user's social and physical activity.

A method and apparatus for creating and maintaining an “online persona” is described in the US Patent Publ. 2012/0259806, which suggests an ability to control how and when the user receives emotional data. It does not teach how to use the user's social and physical activity for determining the user's emotive state, and seems to assume the user's emotional level is static. U.S. Pat. No. 8,380,607 offers a method of investigating public mood from a multi-dimensional model approach and a method to predict economic market trends above chance level based on the multi-dimensional model approach. The text content of several large-scale collections of daily network communications are analyzed via mood assessment tools, measuring various mood dimensions. This application is limited because it relies on monitoring social networks and internet traffic for determining the financial mood of a sector of the population.

US Patent Publ. 2011/0225021 discloses a system and method for emotional mapping of online users. Based at least in part on this emotional mapping, the user is classified into an emotive state from a set of emotive states, which then helps target the presentation of advertisements or content to the user. Its limitation, however, rests on the fact that the system and method is based on content choices only, rather than including the existence and level of online activities.

US Patent Publication 2012/0143693 (the '693 publication) discloses a computer system, a computer-implemented method, and computer readable media configured to target advertisements based on emotive states, and is conceptually similar to the '021 publication mentioned above. The gist of the '693 publication is a system that allows modifications of advertisements based on the user's emotive state. Also, similarly to the '021 publication, the '693 publication uses the “tone of content” for determining emotive states. As explained above, this is completely different from how the present invention operates.

A system and method capable of reducing the effects of negative emotive states by performing physiological measurements of a user with wearable sensors and detecting an emotive state of the user is disclosed in the US Patent Publ. 2012/0323087. The system and method disclosed are limited, however. They only focus on negative emotive states, and the elimination of such negative emotions, and use auto-associative memories in determining how the user feels, rather than psychological signals.

US Patent Publ. 2012/0315613 discloses an online lifestyle management platform designed to address and manage the multiple factors affecting an individual's lifestyle. The lifestyle management platform may include an assessment evaluation tool used to establish a profile for an individual by assessing the individual's lifestyle factors. The lifestyle factors being assessed may include an individual's physical and mental condition, occupational and personal stress factors and goal satisfaction. Based on the profile, the lifestyle management platform generates a customized lifestyle management program such as a stress management program for the individual.

PCT Patent Publ. WO 2011/153318 discloses a system and method using biosensors to track emotive states of a person, and to communicate such collected data with service providers and/or to share with others. The system discloses integrating biosensors on the case of a mobile device. U.S. Pat. No. 8,271,902 discloses communicating emotions using a graphical user interface designed to allow a user to select a particular emotion from a wide range of potential emotions, and tie that emotion to a text messaging system. PCT Patent Publ. WO 2012/166989 discloses assigning emotional qualities to customers and using those qualities to categorize the customers for performing matchmaking in entertainment services. For example, the system disclosed includes parsing data from a variety of inputs, including skeleton mapping, facial reading and recognition, and voice mapping. In addition it discloses monitoring accelerometer data from input devices and other motion data from cameras attached to the systems, and combining the multi-sourced data with the user's social activities.

European Patent Appl. EP 2 630 635 discloses facial pattern analysis software used to recognize emotion in an individual. The focus is entirely on facial recognition software and the codification of emotion therein, and does not include a framework to give the emotive analysis a frame of reference regarding the history of emotive data and of the level of physical and social activity of the user. European Patent Appl. EP 1 532 926 discloses calculating an undefined emotive continuum based on a reading from a pressure sensor on a mobile device, and then storing and/or transmitting the emotive data.

U.S. Pat. No. 7,940,186 discloses a system and method for estimating the mood of a user based on a user's profile data indicative of a user's mood received from a communication device associated with the user and from sources other than the user, and environmental data with a potential impact on the user's mood. Data indicative of the user's mood and the environmental data are processed to filter out data that is not relevant to the user's mood. The filtered data is cross-correlated with the user profile, and the mood of the user is estimated based on the cross-correlated filtered data. A network and services may be controlled based on a user's mood. Suggestions for interacting with the user may be generated based on the user's mood.

In contrast to the systems and methods discloses in the prior art, including those references discussed above, the present invention provides a new and non-obvious approach to assessing an individual's emotive state and conveying that information as needed.

### SUMMARY OF THE INVENTION

Embodiments of the present invention provide a method for collecting and evaluating various factors affected by changes in a person's emotive state and developing an objective picture of the person's current mood or feelings. Many such embodiments permit the person to communicate his/her emotive state to others, which can have various practical uses, from simply uplifting the person's mood, to using the aggregated emotive “mood” information for measuring response to advertisements, financial news and the like, and to assisting the person to improve the emotive state, if so desired.

Embodiments of the present invention provide a system and methodology for non-intrusively evaluating and monitoring a person's emotive state by factoring in the user's usual day-to-day social and physical activities, and, if so desired, relaying such emotive information to others. One feature of embodiments of the present invention is the ability to assess the correlation between a self-assessment of the individual's emotive state, objectively measured parameters of the individual's physical behavior, and the individual's use (and level of use) of various electronic communications and activities.

Some embodiments comprise a computerized system capable of tracking, analyzing and broadcasting the user's emotive state based on the user's online activities coupled with the user's biometric, environmental and geospatial data. In some cases, embodiments of the present invention may not only assess a person's emotive state, but can continuously assess the person's emotive state, comparing it to an established baseline, and performing and/or modifying tasks once a deviation from the baseline has been detected. In some cases, the user's emotive state can be determined along four distinct continuums of emotion, and then quantified by numeric representation of that state on the aforementioned continuums. Features of some embodiments utilize the strength with which different environmental factors impact the user's emotional state to determine the most likely current emotive state of the user. The determined emotive state can then be more easily conveyed electronically in such a form to someone who can modify their interface with the user accordingly.

In one embodiment, a method for enhancing an interaction with a user based upon information about the current emotive state of the user is provided. In one embodiment, the method comprises uploading an application to a mobile computerized device of a user whose present and later emotive states are desired for use in enhancing the interaction with the user, detecting and collecting metric data comprising biometric, geo-spatial and/or activity information about the user by way of one or more sensors associated with or in communication with the mobile computerized device, using the metric data to make further determinations about the user's emotive state, the user's emotive state comprising one of a plurality of categories of emotive states, applying pre-determined weights to each metric with respect to one of the plurality of emotive states so that the relevance of the metric data to such emotive state is taken into consideration, periodically updating each of the weights to reflect changes in the relevance of the metric data to the emotive state to be determined, determining a value corresponding to each of the emotive states; and using the emotive state values to enhance interaction with the user.

In some embodiments, the plurality of emotive states comprises affect, stress, anger and alertness, where affect reflects a continuum from happy to sad and alertness comprises a continuum from sleepy to wide awake. Stress and anger are also on a continuum from highly stressed and very angry to unstressed and not angry. In some embodiments, the metric data comprises one or more of device use, ambient environment, location, and use physical activity.

In other embodiments, a method for monitoring and assessing a person's emotive state using information about their social and physical activity is provided. The method may comprise determining an average baseline of the person's emotive state, monitoring an actual emotive state of the person through the analysis of metrics associated with the person's social and physical activity, determining whether there are deviations of the actual emotive state from the average baselines, predicting a future emotive state based on the average baseline and the actual emotive state; and seeking to modify the person's environment to compensate for the deviation from the average baseline. In some embodiments, the method may comprise average baseline determination logic, actual emotive states determination logic, future emotive state predicting logic, and environment modifying logic.

### BRIEF DESCRIPTION OF DRAWINGS

These and other features of this invention will be more readily understood from the following detailed description of the various aspects of the invention taken in conjunction with the accompanying drawings in which:

FIG. 1 depicts the mechanism for determining average baselines of emotive states;

FIG. 2 depicts the logic for monitoring actual emotive states;

FIG. 3 depicts the logic for managing deviations from average baselines;

FIG. 4 depicts predicting future emotive states mechanism.

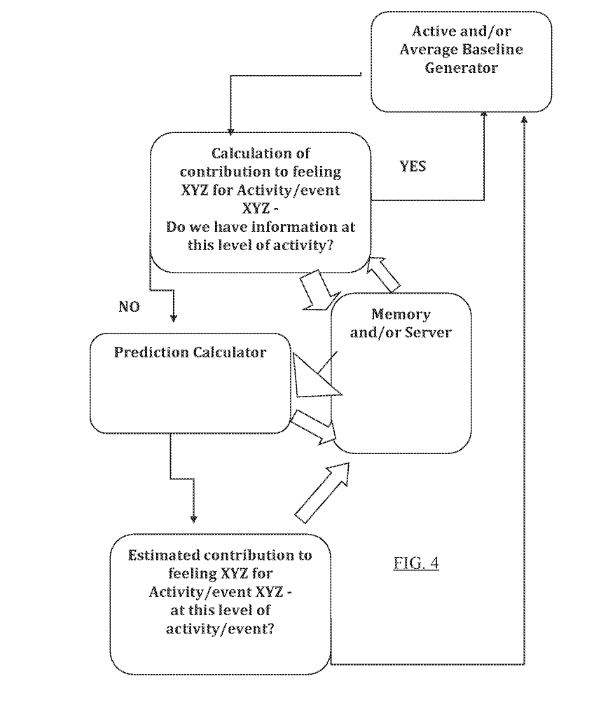

FIG. 5 shows an example of the initialization of a portable computerized device; and

FIG. 6 shows an example of how inputs may be obtained—in the form of a learning mechanism—to change the applicable metric data weight as applied to a particular emotive state to make the weight more meaningful.

### DETAILED DESCRIPTION OF THE INVENTION

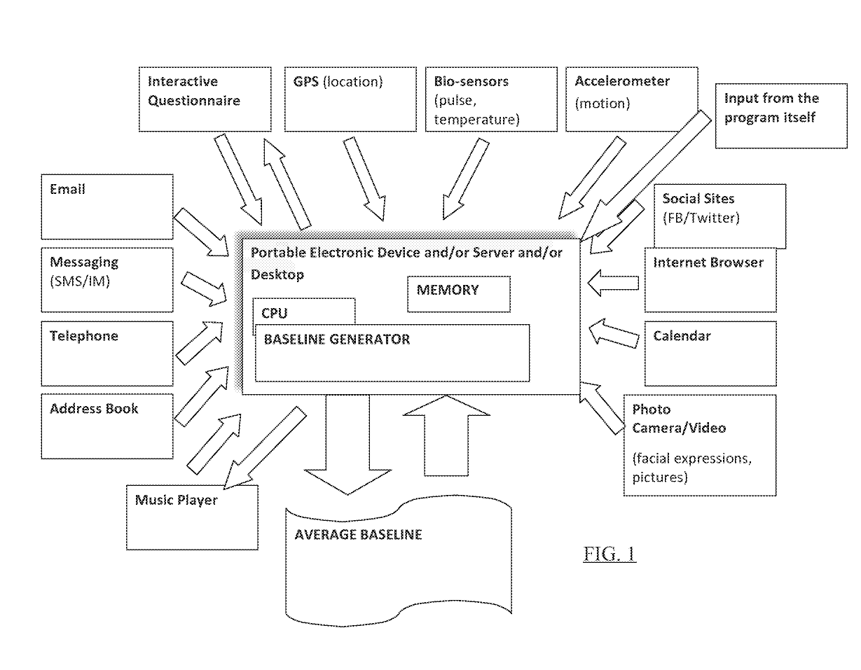

Referring to FIG. 1, one embodiment comprises a system that develops a baseline for the user. The baseline is a combination of the user's emotions or feelings correlated to a specific activity undertaken by the user at a particular time. In one exemplary embodiment, at least some if not more human emotion metrics are measured:

Alert—quick to notice any unusual and potentially dangerous or difficult circumstances;

Happy—feeling or showing pleasure or contentment;

Sad—feeling or showing sorrow; unhappy:

Lonely—sad because one has no friends or company;

Depressed—in a state of general unhappiness or despondency;

Ecstatic—feeling or expressing overwhelming happiness or joyful excitement;

Enthusiastic—having or showing intense and eager enjoyment, interest, or approval;

Tired—in need of sleep or rest; weary;

Joy—a feeling of great pleasure and happiness;

Excited—very enthusiastic and eager;

Stressed—the pressure or tension felt by the person;

Since a person's emotive state (inner emotional feelings) is unique, some embodiments of the present invention allow a user to define their own emotions differently from those listed above.

It is further contemplated that the user is initially asked questions about his/her daily basic routines. In some exemplary embodiments the user is asked how much she works, what causes her to stress out, what makes her happy, when she is happy, when and how much she sleeps, what she does to relax and calm down, how diligent she is in answering emails, how active she is on social media sites, and what she does when sick, among other questions. The user may be asked to evaluate the level of stress while at work or in school, which activities the user likes and does not like, what they when they feel in a certain way—for example, do they shop, run, listen to music, talk to friends, etc. In addition, the user is administered a standard personality test based on the Likert scale in order to determine her personality type and individual character traits.

In one exemplarily embodiment, the initial questionnaire may ask the user to describe the following:
The user's routine for each day of the weak;
How the user's physical and social activities make them feel;
The weights of each event/activity (how important of a contribution is this event to this feeling compared to all the other events);
On average, how do you feel when you commute to work;
On average, what is the weather like when you commute to work;
On average, how do you feel when you arrive to work;
On average, how does heavy rain make you feel
On average, how does heavy traffic make you feel;
On average, how do you feel on a Sunday;
On average, how do you feel when you arrive home from work;
On average, how much do you sleep on a Monday;
On average, how do you feel when you sleep one hour below average;
On average, how often do you check Facebook/Twitter;
On average, how many e-mails do you get on Monday;
On average, how many e-mails do you answer on Monday;
How does receiving 50% more text messages make you feel?
   Here, “physical activity” means any physical movement or change in the physical environment; “social activity” means any social change, including biorhythms.

The initial baselines will be created only from the answers the user has submitted in response to the initial questionnaire. Thus, the information presented by the user describes her average daily routine as well as her average physical and social activity contributing to the average baseline for a given point in time. These baselines serve as references to what is considered to be the user's norm and are a function of time and activities. The baselines are calculated as follows: Level of Emotion ‘X’=(((% from Activity No. 1)×(relative weight))+((% from Activity No. 2)×(relative weight))+((% from Activity No. 3)×(relative weight))+etc.). Note: the number of activities taken into consideration is virtually unlimited, and only relevant activities are taken into account in assessing the overall proportion of Emotion ‘X’; if the activity or the event is irrelevant, it is not taken into account. For example, the user's activities at work will not be factored in if the GPS shows that the user was at home at the time of reference.

As it can be seen from the prior description, those average baselines are constantly changing as old activities/events become irrelevant and new activities/events become relevant. For instance, if the system knows how many e-mails the user receives on average, and how emails contribute to her emotive state, the system should be able to deduce that if the user gets 20% less emails on a given day, her emotional level for stress that accompanies this activity will probably be 20% lower.

As already discussed, the initial questionnaire contains questions attempting to correlate certain emotions to the specific activities of the user. For example, the user may be asked to assess her feelings and her emotive state while she is commuting to work. This assessment can be done using any numerical scale. In one exemplary embodiment, an Emotional Level Value (EVL) Scale may be used, where 1 may be designated the lower level of a specific emotion and 10 may be designated the highest. In another embodiment, the system may use percentages, where 1 EVL corresponds to 10% of a given emotion, 2 EVL to 20%, and so on. On scales of 10, for example, if the user checks ‘1’ for being stressed, ‘8’ for being happy, and ‘3’ for being sad, the user indicated that her expected level of emotions during commuting to work is 1 EVL out of 10 for stress, 8 EVL out of 10 for happiness, and 3 EVL out of 10 for sadness. As already mentioned, the user may enter and then evaluate his/her own emotions and activities not listed in the questionnaire. By checking ‘0’ the user indicates emotions that are irrelevant for a given activity.

From the answers to the initial questionnaire, the system creates an average baseline. The baseline is a correlation between the average activities the user engages in on a given day and at a certain time, and the user's average emotional levels accompanying those activities. Once the system creates the baseline, it further customizes it based on the new activities undertaken by the users. Initially, the customization is mostly done by asking the user to evaluate her emotional levels once the new activity has been detected. For example, when the system sees the user browsing the Internet or posting Twitter messages for the first time, it may ask the user to assign the same 1 through 10 EVL, or 10% to 100%, to those activities.

Once the initial baselines are determined, the user's actual emotional levels at a given time are calculated using inputs from the following open and non-exclusive list of sources.

From eMail:
How many e-mails the user receives;
How many emails has the user responded to
How many emails has the user read
How many are classified as “business,” “friends”, etc.

From Calendar:
How many meetings has the user had;
When and where were the meetings held;

From Text Messages:
How many messages have been received and from whom;
How many messages have been answered;
How many messages have been read but not answered.

From Social Media—FB, Twitter, and LinkedIn:
How many times has the user logged in/accessed the application/website;
Time spent online.

From GPS:
Location of the user (device);
Direction;
Weather at the location;
Traffic conditions at the location;
Local time at the location;

From Accelerometer:
Speed of the user (device)

From Bio-Sensors:
Pulse of the user;
Body Temperature;

From Telephone;
Number of calls received;
Number of calls made;
Number of voice mail messages received;
Number of calls unanswered;
Who were the calls from;
Who were the calls to.

From Address book:
Target audience for the user's communications;
Used in conjunction with SMS/IM/Social Media and telephonic applications

From Built-in photo & video cameras/Photo Album:
Used as a collection of still and moving uplifting images;
Collection of the user's facial expressions;

From Media Player:
Uplifting and soothing rhythms;
   If the average baseline remains static for a specific activity at a specific time, the actual emotional level of the user is constantly changing because it reflects what the user is actually experiencing at this very moment.

To determine the user's actual emotional level, some system embodiments first receive all relevant information from all available sources as shown above. Then the systems incorporate and compare the information with the information received from the user's direct input. For example, from the Calendar the system determines the number, time and locations of all meetings scheduled for today. It then compares this information with the user's direct input and determines her average baselines for all the emotions associated with the meetings. In one hypothetical example, assuming that the user indicated an average of 10 meetings per day, and that having 15 meetings on one particular day would cause much greater stress and much less happiness, if the user's calendar reflects 15 meetings on a particular day, the system would determine a higher stress level for the person. Some systems also assess the number of hours actually slept that day, the number of hours the user sleeps on average, and the relevant contributory value of this sleep difference to a specific emotion. The formula applied to calculating the average baseline may be as follows:

Actual Level of Emotion X=(((% from Activity No. 1)×(relative weight))+((% from Activity No. 2)×(relative weight))((% from Activity No. 3)×(relative weight))+etc.).

Again, the actual level of emotions is the combination of all emotions related to a specific activity.

In some embodiments, the system calculates the difference between the baseline and the real time emotive status, and where the difference is substantial and exceeds a certain threshold (i.e., action point), the system may take further action. These action points, which reflect the relevant proximity between the average baseline and actual emotional levels, are set by the user. Examples of actions that may be taken based upon the results may include and are not limited to:
Sending a picture or video via e-mail, text, or pop-up message;
Sending an uplifting text, as in inspirational quotes;
Contacting designated friends to tell them to stop e-mailing or contacting the person;
Sharing the emotional fluctuations through a social media site;
Altering screen brightness of the mobile device;
Changing background images of the device;
Playing uplifting or calming music;
Alerting third parties and other interactive applications; and
Interacting with other electronic devices, e.g. entertainment systems, audio and video devices, etc.
   As long as the system has at least two data points—one average and one actual—the system will be able to predict the user's emotional level and take action based on that information.

Finally, as the user interacts with the system more often, the system will gather more data points that will make its predictions more accurate. For instance, if the system knows more than two data points, a graph may be plotted using the linear equation y=mx+b that allows the system to determine the average slope and change of the emotional levels in proportion to a given activity and event.

Referring again to FIG. 1, the system collects information about the user's activities from a plurality of sources. As shown, in one exemplary embodiment the information is sourced from a built-in GPS, accelerometer, and biosensors. In another embodiment, the information will come from applications supporting email, social media applications, such as Facebook, LinkedIn and Twitter, Instant and Text messaging. Yet in another embodiment the information will be provided by weather-reporting applications, internet browser, built-in photo and video cameras and photo album, built-in telephonic software, address book and the like.

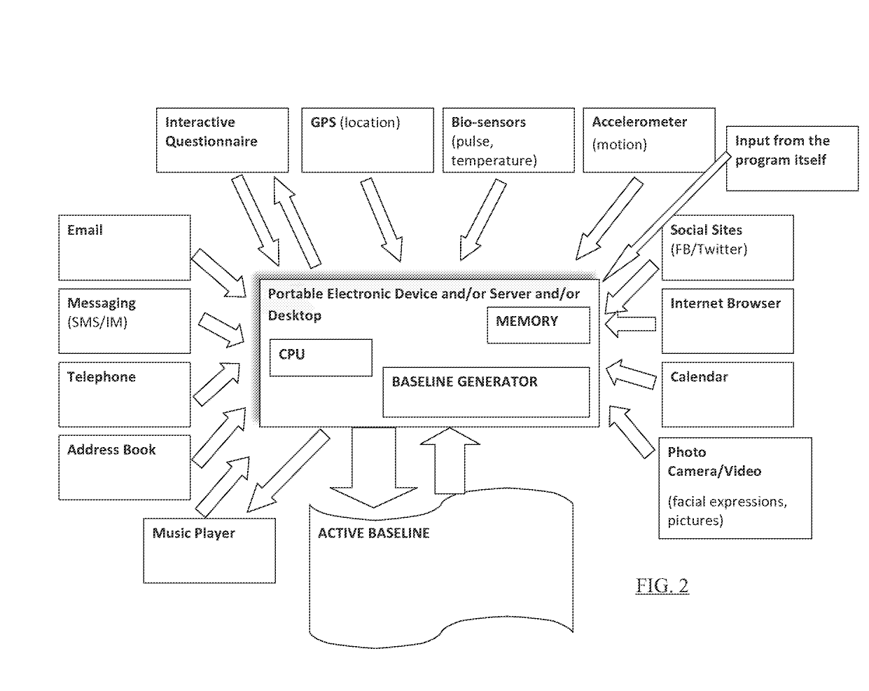

As the system collects and retains more information about the user's activities and correlated emotional levels, the baseline becomes more and more complex, which in turn allows the system to rely on the user's direct input to a lesser degree. Upon collecting the activity information from all of the variety of sources, the user's baseline is continuously compared to the level of the user's current activities. In this embodiment, if the user's deviation from the baseline persists over time, the system will attempt to modify the baseline according to the new values. Thus, referring to FIG. 2, if the baseline is not optimal, then the system automatically adjusts the baseline. If the baseline is optimal, then no changes are made. Yet in another embodiment the user may disable automatic baseline maintenance and treat the system's output in the form of recommendations for consideration. Also, the user has the ability to change the baseline manually to reflect changes in her activities or daily routines.

In addition to collecting and modifying the user's dynamic baseline, the present invention tracks the user's deviations from the baseline. As already established, based on the user's direct input the system learns the activities and the emotive states associated with them, i.e. what makes the user sad, stressed, happy, excited, ecstatic, depressed, etc. For each of these emotive states the system keeps track of corresponding emotional value levels (EVL). Therefore, the system knows the expected baseline emotional value levels for each “learned” activity. Actual emotional levels are computed based on the user's previous input, her current biological metrics, such as temperature and pulse, geo-positioning, social network activity, and others. By comparing that expected baselines values to the actual values the system is capable of detecting baseline deviations and their levels.

The system also possesses an ability to extrapolate, from the user's input, and determine expected emotional levels in new but expected situations. For instance, if the system knows that this user is 10 EVL stressed when the traffic is at a standstill and is not stressed at all when there is no traffic, the system assigns stress level to five when the traffic conditions are medium. In another exemplary embodiment, in addition to using the user's social network activity and her geospatial and biometrical information, the system takes into account the content of the user's postings, comments and messages, and then correlates certain patterns to specific emotive states experienced by the user.

As already established one of the functionalities of the present invention is modifying the user's environment and adjusting the user's emotive state back to the expected or desired levels. The modification of the user's environment is accomplished by contacting the user directly, changing information presented to the user, contacting the user's friends, changing the user's devices, among other means. The system performs certain actions if the level of a specific emotion falls below or exceeds an established threshold. By doing so, the system attempts to modify the user's environment so as to bring the user's emotive state closer to the baseline. For example, the user may request that a picture of his dog be displayed on the user's phone if she is more than 5 EVL sad, or a friend may be notified by text message if the user is less than 3 EVL happy.

In addition, embodiments of the invention may take advantage of access by the user to social media sites, where the user may share emotional information, observe daily fluctuations of feelings, analyze the trends and determine correlations between activities undertaken and the emotive states experienced. The user will also be able to see her friends' emotional fluctuations providing that appropriate consent is granted. The information collected may be used in numerous ways to benefit the user and those that interact with the user. For example, the system may be used to help the user determine the best time for buying a car, or whether or not eating certain comfort food is a good idea.

For instance, the system has learned from Maria's direct input that when Maria gets around fifty emails a day, gets home around 9:00 pm, and sleeps around five hours (the system determines when the user is asleep by knowing when the phone is being charged, previous user's input, and by the fact that the phone is not being moved), she is stressed at the level of 5 EVL, or 50%, and is happy at the level of 6 EVL, or 60%. Furthermore, the system weighs in the amount of sleep, the number of e-mails unanswered, the amount of time spent at work and other appropriate factors to find out the actual emotive state of the user. For example, if Maria is usually 60% stressed when she comes home on time, and is stressed 25% more if she comes home an hour late, the system would be able to detect that Maria is actually 75% stressed (60+0.25*60) if she indeed came home later by one hour. Similarly, if Maria slept for three hours instead of the usual five hours, the system would determine that Maria is 65% more stressed out than usual since sleep is an important factor for Maria's emotive state. That process is continuous and takes into account all that makes Maria more or less stressed. This process is repeated for all other Maria's emotions.

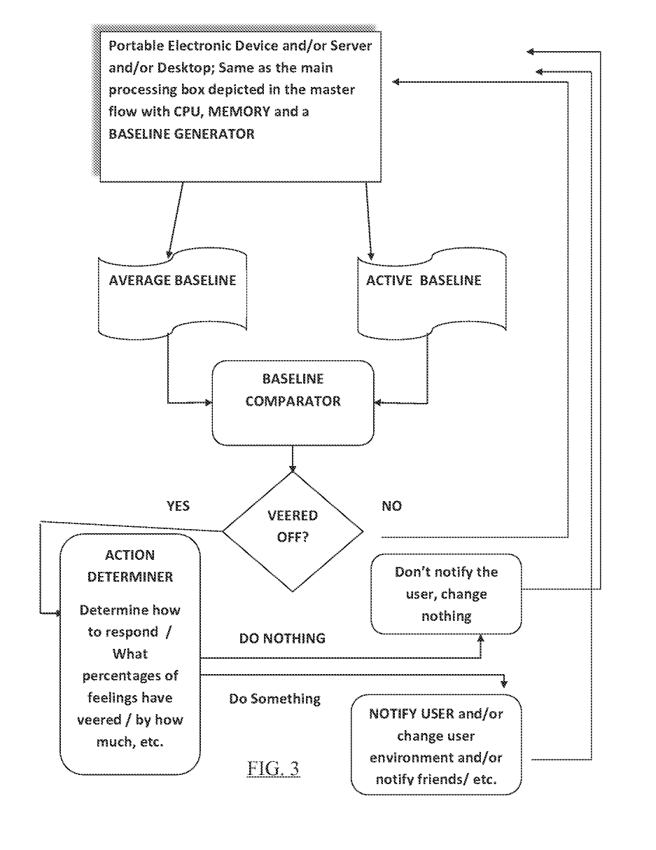

The following usage scenario is an illustration of the process flow depicted in FIG. 3. As in the example above, assume the user indicated that while commuting to work she usually is 1 EVL stressed (10%), 8 EVL happy (80%) and 3 EVL sad (30%) under normal traffic conditions, and is completely stressed (100% or 10 EVL), and 50% , or 5 EVL sad in heavy traffic . Let's also assume that from a combination of the built-in GPS and map & traffic applications, the system detects heavy traffic conditions during the user's commute to work on a given day. The system then re-recalculates the user's current emotional level as 5.5 EVL (55%) stressed using formula (10+1)/2), 4 EVL (40%) happy ((0+8)/2, and 4 EVL (40%) sad ((3+5)/2). By comparing the average work commuting baseline to actual commuting data, the system learns that the user's emotive state while commuting to work has deviated from the norm: the user is more stressed, less happy and much sadder. Now the system is aware of the deviation and may then proceed in one or ways, such as those suggested or discussed above. For example, because the user is less than 5 EVL happy, the system may notify the user's friend via a text message, and because the user is more than 3 EVL sad, the system may display a picture of her dog on her mobile device.

Another exemplary embodiment of the system is described in the following usage scenario. Let's assume that on a typical Monday, Tom receives 10 text messages, all of which he answers. He also usually attends all his scheduled Monday meetings, and opens Facebook three times. This particular Monday, however, the system learns from the calendar, email and GPS applications that Tom missed all his meetings, answered only five messages, and hasn't checked his Facebook at all. The system also knows that the last time Tom deviated from the baseline in this manner, he was stressed out and very sad. The system is now able to determine a high probability that Tom feels sad and is stressed out. Accordingly, it will attempt to bring Tom's emotive state back to the baseline relying on prior instructions.

In another usage scenario the system detects that Maria receives 45 emails on a particular day. If the system knows from Maria's prior input that receiving 50 emails a day makes her 10 EVL, or 100%, stressed, the system will estimate Maria's current level of stress to be 9 EVL.

In certain embodiments the system is configured to modify the user's environment by communicating with the user directly through text messages, emails, pop-up messages, or the like. The content of these messages is in part determined from the user's previous inputs. For example, if the user crosses a certain threshold of being sad or depressed, the software will contact the user with information that the user has previously indicated as uplifting. In another embodiment the system shares the information about how the user feels with others through other applications, social networks, advertisers, etc. so that the information shared more closely reflects how the user actually feels. Yet in another exemplarily embodiment the user designates friends whom the system should contact when the user experiences certain emotional levels. For example, if the system determines that the user must be feeling lonely because she received less correspondence than indicated from her average baseline, the system may alert the user's friends. In addition, the system may modify the appearance of the user's devices to reflect how the user feels. For instance, the software may change the devices' background image and the screen brightness as well as other display characteristics that are helpful in bringing the user's emotive state back to the baseline.

Other embodiments of the present invention provide systems and methods for assisting users with managing, monitoring, broadcasting and adjusting their emotive states. The utility of such embodiments is fairly broad. For example, if a business knows its customer's emotive state, the business can modify its customer interface to uplift, to calm or to excite the customer. Or the business might simply improve its service to the customer by knowing the customer's emotive state. In one example, if a hotel possesses an objective picture of its guests' emotive states, the hotel can accentuate the guests' room accordingly. Online service providers, entertainers, social workers and others can use the same principles in improving their customers' experiences.

For purposes of describing certain embodiments of this invention, a naming convention has been applied for ease of reference. In the case of the AP metrics, AP-01 reflects the value for metric 01, which may be for example “device use.” AP-02 may be ambient temperature, and AP-03 may be walking status (i.e., whether the user is presently walking or not).

These values are established from previous assessments, and are continuously developed, updated and enhanced over time to improve initialization of the software for future users. Each of these values is preferably tied to a single metric that quantifies some aspect of the user's environment. The values are also preferably tied to a single emotive continuum that defines a one-dimensional scale of emotion that a person can experience. In some embodiments, four continuums are employed to cover the range of human emotions, although fewer or greater numbers emotive continuums may be employed. Where four are used, those four can be (1) Affect (Happiness-Sadness); (2) Stress; (3) Anger; and (4) Alertness (Awake-Sleepy). At a high level, there are four emotive states: ES-A (Affect), ES-B (Stress), ES-C (Anger) and ES-D (Alertness).

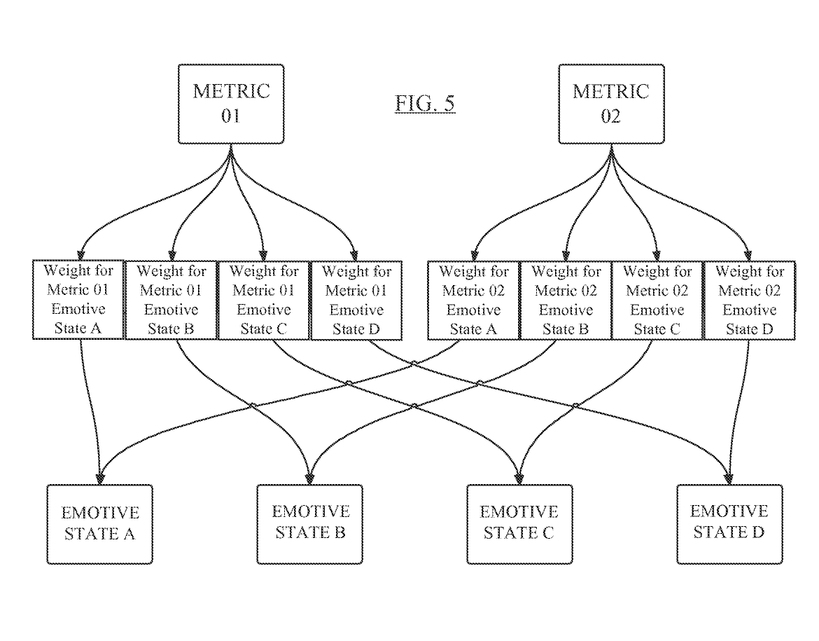

In some embodiments of the present invention, the system comprises software usable on a computer device, such as a mobile device (e.g., smart phone), equipped with a variety of sensors. Referring to FIG. 5, during initialization, the system is established with a preformatted state comprising of a set of weighted association values for each identified metric that the system is intended to address. The action point (AP) metrics may include but are not limited to:

Ambient light levels

Sound pressure levels

Accelerometer-detected motion

Location data

Location-dependent weather data

Contextual location information

Activity levels on social networking services such as: Facebook, Twitter, etc.

SMS activity levels

Phone usage

Estimated sleep levels

Estimated exercise levels

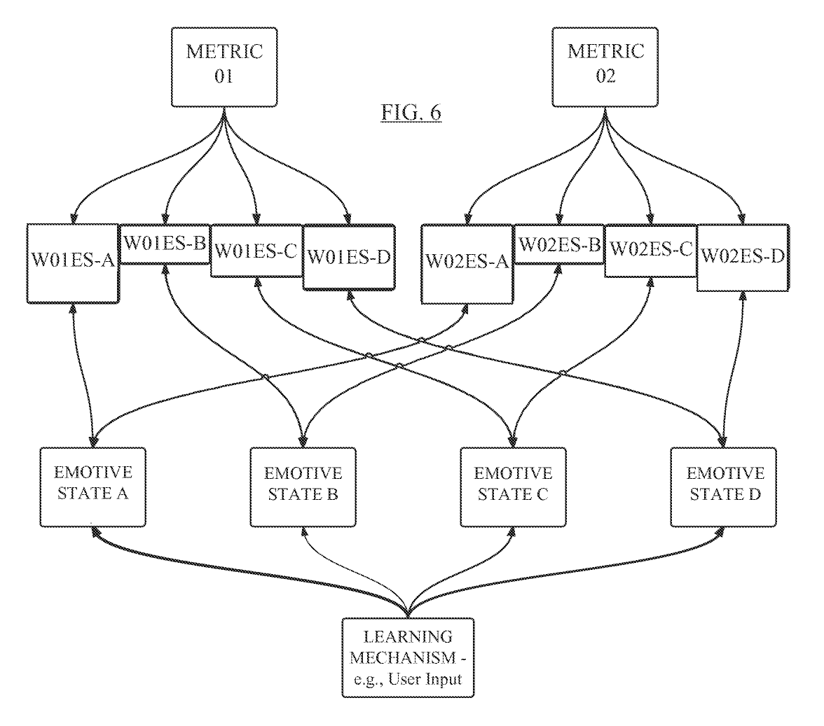

As such, each emotive metric is associated with four weights, each of which is in turn tied to a different continuum. With reference to FIG. 6, while the system is running on a mobile device, for example, the emotive metrics are periodically calculated and updated as new sensor data becomes available to the system. It is worth noting that continuous rather than periodic analysis may be employed in some embodiments with respect to all factors that are detected, measured and/or determined. In order to improve the value of the system and methodology of the embodiments herein, an advantageous feature is the ability to incorporate a learning mechanism into the system, where information about the actual emotive state of the user may be directly input by the user and/or obtained from other sources. For example, the user may be periodically requested or prompted to input information for a finite period of time to help refine the weight associated with the metrics for each emotion.

The AP metrics are normalized, multiplied by their respective weights, and then summed along their associated continuums in order to produce the total emotive value of each continuum. As the metrics fluctuate throughout the day, while the user goes about his life, the emotive values also fluctuate in a fashion that reflects the impact those metrics have on the user's emotive state.

The process of producing an emotive value for each of the four emotive continuums is repeated at a specified interval on the device in which the system has been installed. The values are preferably saved onto the device and, if so desired, an external server designated for the storage of this data as well. In this way, emotive data for the user is regularly collected, forming a history of data to be explored and mined.

To access this data, system embodiments include a means of accessing the stored data by one or more vehicles. Access to this stored data can be valuable to those who provide services to the user and/or those who interface with the user. Thus, embodiments of the invention include means for communicating such data passively, actively, and/or automatically, between the person whose emotive state is being assessed and those who wish to obtain such information to provide enhanced service or person interface.

By way of example, assume Company ABC provides services to a user and/or interfaces with the user, and that Company ABC desires to enhance its service or interface experience with the user. Company ABC may thereby employ systems and methodologies of the present invention, for example in the form of software or application, that creates access to emotive data of the user developed and stored by the user's mobile device with corresponding software or application. Both Company ABC and the user would therefore require such software or application to be installed on their associated electronic computing device. The system will begin to collect information from the user, and will begin producing emotive data in response to the sensor information that the user's device is providing the system. This emotive data is stored on Mark's phone at set intervals in a form that permits contemporaneous or later transmission. With such an arrangement, the system can work passively (i.e., automatically) whereby emotive data is obtained by the sensors and monitors associated with the user's mobile device and then transmitted to Company ABC periodically or as solicited by Company ABC. Or the user can initiate such transfer.

For purposes of following the calculations, and using ES to refer to emotive state, and AP to refer to the metrics, as explained above, the following definitions are also used: AP-01ₙ₀ is the initial measurement (n=0), between 0 and 1, for metric 01; AP-01ₙ₁: is the first interval measurement (n=1), and AP-01ₙ₂ is the second interval measurement (n=2). API-01 is the time interval at which metric 01 is measured and iterated. APA-01 is amount that metric AP-01 is adjusted at every API-01 interval (+/−). For a first interval measurement, AP-01ₙ₁=AP01ₙ₀+APA-01, and the second interval measurement is AP-01ₙ₂=AP-01ₙ₁+APA-01. The same is true for the second metric, AP-02. In other words, AP-02ₙ₀ is the initial measurement (n=0), between 0 and 1, for the second metric, while AP-02ₙ₁ is first interval measurement (n=1), and AP-02ₙ₂ is the second interval measurement. APA-02 is the amount that metric AP-02 is adjusted at every API02 interval (+/−). For a first interval measurement, AP-02ₙ₁=AP-02ₙ₀+APA-02, and for the second interval measurement, AP-02ₙ₂=AP-02ₙ₁+APA-02.

Likewise, each emotive state has an initial and later iterative value. Where ES-A refers to one emotive state (Affect, e.g.), ES-Aₙ₀ is the initial measurement (n=0), between 1 and 13, for Affect; ES-Aₙ₁ is first interval measurement (n=1), and ES-Aₙ₂ is the second interval measurement. ES-IA is the interval at which emotive state A is updated. Likewise, ES-Bₙ₀ is the initial measurement (n=0), between 1 and 13, for emotive state B (Stress), ES-Bₙ₁ is the first interval measurement (n=1), and ES-Bₙ₂ is the second interval measurement (n=2).

Turning to weights assigned to each metric relative to one of the emotive states address, W01ES-Aₙ₀ is the weight assigned to AP-01 for emotive state ES-A at initial calculation (e.g., device use metric for Affect emotive state); W01ES-Aₙ₁ is the weight assigned to AP-01 for emotive state ES-A at a first interval, and W01ES-Aₙ₂ is the weight assigned to AP-01 for emotive state ES-A at a second interval. Likewise, W02ES-Aₙ₀ is the weight assigned to AP-02 for emotive state ES-A at an initial calculation, W02ES-Aₙ₂ is the weight assigned to AP-02 for emotive state ES-A at a first interval, and W02ES-Aₙ₃ is the weight assigned to AP-02 for emotive state ES-A at a second interval. W01ES-Bₙ₀ is the weight assigned to AP-01 for emotive state ES-B (Stress) at an initial calculation, W01ES-Bₙ₁ is the weight assigned to AP-01 for emotive state ES-B at a first interval, and W01ES-Bₙ₂ is the weight assigned to AP-01 for emotive state ES-B at a second interval. Likewise, W02ES-Bₙ₀ is the weight assigned to AP-02 for emotive state ES-B at an initial calculation, W02ES-Bₙ₂ is the weight assigned to AP-02 for emotive state ES-B at a first interval, and W02ES-Bₙ₃ is the weight assigned to AP-02 for emotive state ES-B at a second interval.

There are at least two different ways to convert sensor data into AP metrics. They differ based upon whether (i) the metric has a binary character, such as on/off, high/low, etc., or whether (ii) the metric simply reflects a point along a spectrum, and may fall within or without a predetermined range. One example of a binary AP metric is whether the mobile device is being used at the point in time in which an assessment is made. With such a metric, it is fairly binary in character in that the device is either on or off Of course, in other embodiments, levels of use may be considered, such as how the user is using the mobile device. It may also be taken into account for how long prior to the assessment point that mobile phone has been on continuously. For purposes of explaining an example of a binary metric, however, the example will not consider levels or use or prior continuous usage. In this one example, “device use” may simply be characterized as being either on or off When it is on, a first AP “device use” adjustment to the AP metric is applied, usually an increment to the last iteration of the AP metric value. When the mobile phone is off, a second AP “device use” adjustment to the AP metric is applied, usually a decrement.

The second type of metric is one that is not as readily characterized as binary, although in some instances it could be. Ambient temperature is an example, where the AP value corresponds to the actual temperature at a point in time. When addressing these types of metrics, the AP value utilized by embodiments of the present invention reflects a comparison between the actual data point and a pre-determined range that may be associated with user comfort, for example. In making the comparison, a new AP value is calculated when the temperature is outside the “comfort” range (where, in this example, the AP value is set to zero when the temperature is within the comfort range). An initial determination is whether the actual temperature is less than or greater than the comfort range. If the actual data point (temperature) falls above the comfort range, then the AP value is calculated as:

$$AP \text{-} 02 ( temperature ) = \frac{actual temperature minus upper end of range}{upper end of range minus the lower end of range}$$

Where the actual temperature falls below the comfort range, then the AP value is calculated as:

$$AP \text{-} 02 ( temperature ) = \frac{lower end of range minus actual temperature}{upper end of range minus the lower end of range}$$

By incrementing or decrementing the previous AP value when acquiring new binary sensor data, some history of the previous AP value is preserved (i.e., AP-01ₙ₂=AP-01ₙ₁+APA-01). By assigning a new AP value with a non-binary metric, the prior history of AP value is ignored.

In one specific example, device use (AP-01) is measured by checking at set intervals (20 seconds) whether or not the device screen is on. This information is transformed into a single AP-01 (device use) [or it could be AP-01 (device on) and AP-02 (device off)]. This transformation is performed as a simple if-then statement: if the device's screen is on, increase the APA by a set amount 0.01 (APA-01), and if the device's screen is off, decrease the AP by a set amount 0.005 (APA-01), where the AP value is bounded between 0 and 1.

Once every set interval (API)—e.g., 5 minutes—we perform an emotive continuum recalculation (ES-Xₙₓ), in which we recalculate all of the emotive values based on the current AP values. When this occurs, the current value of the device use AP is multiplied by each of its four weight values WXES-Y (one for each continuum) to determine the impact of the user's device use on each of the continuums.

For example, if user Adam has a device use AP-01 value of 0.45, and his weight values for the device use AP metrics are 0.0 for Affect (W01ES-Aₙ₀), 2.0 for Stress (W01ES-Bₙ₀), 1.0 for Anger (W01ES-Cₙ₀), and 1.5 for Alertness (W01ES-Dₙ₀), then his device use is contributing 0.0 (ES-A for AP-01) to his Affect value, 0.9 (ES-B for AP-01) to his Stress value, 0.45 (ES-C for AP-01) to his Anger value, and 0.675 (ES-D for AP-01) to his Alertness value.

The contribution of each AP for a given emotive continuum is summed together to produce the total emotive value for the user at that time. For example, if user Adam has a local temperature (AP-02) AP of 0.5 with a corresponding stress weight of 0.5, the sum of that AP's stress contribution (0.25) would be added to the device use value of 0.9; if these were the only two AP values above 0, user Adam's stress value would be 1.15.

$$\begin{matrix}Stress ( ES \text{-} B ) = 2.0 ( W 01 ES \text{-} B ) \times 0.45 ( AP \text{-} {01}_{n 0} ) + \\ 0.5 ( W 02 ES \text{-} B ) \times 0.5 ( AP \text{-} {02}_{n 0} ) \\ = 1.15\end{matrix}$$

If Adam also had a walking activity (AP-03) value of 0.1 with a corresponding Stress weight of −2.0, his stress value would be 0.95

$$\begin{matrix}Stress ( ES \text{-} B ) = 2.0 ( W 01 ES \text{-} B ) \times 0.45 ( AP \text{-} {01}_{n 0} ) + \\ 0.5 ( W 02 ES \text{-} B ) \times 0.54 ( AP \text{-} {02}_{n 0} ) + \\ - 2.0 ( W 03 ES \text{-} B ) \times 0.1 ( AP \text{-} {3}_{n 0} ) \\ = 0.95\end{matrix}$$

Expanding the example to include weight recalculation, where a weight assigned to a metric X for an emotive state Y is WXES-Y, using direct user input to adjust the weight, keeping in mind that other sources of weight adjustment are contemplated (such as user habits or outside inputs), WXES-Yᵢ, is the weight to be adjusted (with i being one source of input, in this case direct user input. From the above hypothetical Stress value of 0.95, where in one embodiment the bounded range for the weight is 1 through 13, the 0.95 value is rounded up to 1.0. If the mobile device user were to indicate (through a UI element in the application, for example) that he felt his Stress level (i.e., Emotive State Value) was actually 2.0 and not 1.0, the weights of all of the APs that were non-zero at the time of his input would be recalculated. In the case where the Stress range is from 1 to 13, for example, the assumed Stress level (ES-Bₐ) of 0.95 may be rounded up to 1. The user-designated Stress level (ES-Bᵢ)=2.0. The method of calculation splits the weight change into two components: a “fixed” component and a “variable” (or “decrementing”) component. Splitting the weight change into fixed and variable components allows for consideration of which AP metrics have more impact on the weight assigned to the AP metric vis-à-vis any one of the four emotive states (Affect, Stress, Anger and Alertness). The weight delta equals the change in the emotive state (for a particular AP metric) divided by the sum of all of the AP values.

$$Stress weight delta ( Δ WXES \text{-} B ) = \frac{ES \text{-} {B}_{i} - ES \text{-} {B}_{a}}{AP \text{-} 01 + AP \text{-} 02 + AP \text{-} 03}$$

For example, if a user inputs that his stress is a 2.0, not a 1.0 as presumed, the weight delta (ΔWXES-B) for the Stress emotive state is 1.0. If the AP's (AP-X) for Stress (ES-B) were 0.45, 0.5, 0.1, respectively, the total AP value (AP-01+AP-02+AP-03) would be 1.05. So, the weight delta for each of the Stress weights for these APs would be:

$$Stress weight delta ( Δ WXES \text{-} B ) = \frac{2.0 - 0.95}{1.05}$$

$$\begin{matrix}Stress ( ES \text{-} B ) = [ 2.0 + 1.0 ( W 01 ES \text{-} B ) \times 0.45 ( AP \text{-} {01}_{n 0} ) ] + \\ [ 0.5 + 1.0 ( W 02 ES \text{-} B ) \times 0.5 ( AP \text{-} {02}_{n 0} ) ] + \\ [ - 2.0 + 1.0 ( W 03 ES \text{-} B ) \times 0.1 ( AP \text{-} {3}_{n 0} ) ] \\ = 1.35 + 0.75 + - 0.1 \\ = 2.0\end{matrix}$$

If the user input (or any other source of emotive level) were entirely correct, then the calculation above should match what the user identified his emotive state (Stress) was. Applying the same weight change to each weight regardless of its AP value is a less valuable approach than factoring in the AP value when calculating the weight change to apply; a lower AP value indicates a lower relevance, and should therefore receive a smaller weight change than a higher AP value would receive. Additionally, the source of the new/changed emotive value (e.g. user input) is not likely to be completely accurate; it is therefore less valuable to adjust the weights so that they completely reflect the new emotive value than it is to adjust the weights so that they only partially reflect the new emotive value. Thus, a fixed- and variable-weight delta component are considered.

The weight delta (ΔWXES-Y) between the two components is split based on how much an AP metric contributed to the total AP value, defined as a “scaling factor.”

$$scaling factor ( SF ) = \frac{the number of non \text{-} zero APs times the AP being examined}{the sum of all APs less the AP being examined}$$

The scaling factor can be used to determine how much of the weight change can be assigned to a fixed weight component and a variable weight component.

$$fixed weight delta ( FW Δ ) = \frac{SF times weight delta}{SF + 1}$$

$$variable weight delta ( VW Δ ) = \frac{weight delta}{SF + 1}$$

So, for the above example, if the AP value for the local temperature (AP-02)=0.5, the scaling factor (SF) for this AP is:

$$\begin{matrix}scaling factor ( SF ) = \frac{3 ( total non \text{-} zero {AP}^{’} s ) \times 0.5 ( AP \text{-} 02 )}{1.05 ( AP \text{-} 01 + AP \text{-} 02 + AP \text{-} 03 ) - 0.5 ( AP \text{-} 02 )} \\ = 2.72\end{matrix}$$

and the fixed and variable components of the weight will come out to (keeping in mind that scaling factor is the fixed valve divided by the variable value):

$$\begin{matrix}fixed ( FW Δ ) = \frac{2.72 ( SF ) \times 1.0}{2.71 + 1} \\ = 0.73\end{matrix}$$

$$\begin{matrix}variable ( VW Δ ) = \frac{1.0}{2.71 + 1} \\ = 0.27\end{matrix}$$

To appreciate how these fixed and variable values are used to adjust the weight assigned to each metric relative to one of the four emotive states, it is first important to note that the weight assumptions above have a fixed and a variable component, although in each case, the variable component is zero. The weights identified above for the three AP metrics 01 (device use), 02 (temperature), and 03 (walking status) as applied to the second emotive state Stress were 2.0, 0.5, and −2.0, respectively. Preferably, those weights could be more accurately described as (2.0=2.0 fixed+0.0 variable), (0.5=0.5 fixed+0.0 variable), and (−2.0=−2.0 fixed+0.0 variable). In other words, the weight reflects the fixed and variable components added together, and where the variable value is zero, the weight will equal the fixed component. Nonetheless, those two components are maintained separately in the database to more effectively adjust the weight based upon later input.

When new fixed and variable values are calculated, such as shown above, the weight for the AP metrics 01, 02 and 03 would be adjusted as follows

W01ES-Bₙ₂=(W01ES-Bₙ₁Fixed+FWΔ)+(W01ES-Bₙ₁Variable+VWΔ)

W02ES-Bₙ₂=(W01ES-Bₙ₁Fixed+FWΔ)+(W02ES-Bₙ₁Variable+VWΔ)

W03ES-Bₙ₂=(W01ES-Bₙ₁Fixed+FWΔ)+(W03ES-Bₙ₁Variable+VWΔ)

In the case of the second metric 02, for example, the new weight for Stress W02ES-Bₙ₂ equals:

(0.5+0.73)+(0.0+0.27)=1.23+0.27=1.5

The fixed component of the weight change is permanent; in contrast, the variable component returns to 0 over time. This allows for less relevant APs (APs that are closer to 0) to receive smaller permanent changes than more relevant APs (APs that are closer to 1) without the need for more complex polynomial math and recursively-defined calculations, while still allowing the complete calculation (weighted AP calculations) to represent the new emotive value that the user has input into the system. Over time, as the variable component of the weight returns to 0, the emotive value will drift away from what the user gave as his input; this kind of incremental learning, in addition to separating low- and high-relevance APs, can allow us to adapt to users that show certain trends in their responses (for example, a user who gives only small adjustments might have more allocated to the fixed component than a user who regularly inputs large changes). This trend is designed to address the fact that users tend to overcompensate when they identify an emotive state.

When the weight change first occurs, the weights will precisely reflect the input given, but over time the variable component will return to 0 (e.g., after one hour the example weight would be (1.23 fixed, 0.27 variable), but after 6 hours, it would be (1.23 fixed, 0 variable), assuming no other weight changes occur in the meantime. How much the weight is permanently changed is based on how much of the weight change is assigned to the fixed component, which is determined by the magnitude of the AP tied to the weight at the time of the change relative to the sum of all of the APs (i.e. the scaling factor). To give another example, the third AP metric weight (−2.0 fixed, 0.0 variable)) has a scaling factor of 0.285, which gives a weight delta of (−1.78 fixed, 0.78 variable). With this metric (vis-à-vis Stress), more weight has been placed in the variable component here compared to the fixed component, which reflects the lower relevance of the AP metric to the user's emotive state being assessed at the time of the change.

Some embodiments of the invention are implemented in the form of a library with limited accessible that an application developer could incorporate into an application that may vary the interaction with a user based upon information about the user's emotive state. By incorporating the library into the application, the application may be tailored to the user based upon the user's real-time emotions.

The emotive values calculated by embodiments of the present invention may be stored locally on the user's mobile device and may be sent to a central server for data aggregation purposes. The developer has two options from there on how to access that emotive data: he can access it directly on the device, which would give him immediate information about that particular user, or he can access it through our application programming interface, which would give him either data about the individual or about the aggregate total of all of his users (but likely with a considerable time lag, since the user(s) might not be on an active data connection when the developer queries our servers). With that emotive data in hand, the developer can do any number of things; he could feed the data through his own decision-making process on whether or not to perform a behavior (for example, whether or not to serve a particular ad to the user, or whether or not to send the user a notification to try and increase engagement with his app); he could alter the service he provides in some way (e.g. sending a message to the user, changing what music is playing or being recommend to the user, changing the screen brightness or volume of the device), or he could combine the emotive data with other behavioral data to better understand his customers (for example, learning the likely emotional state of a user when they enter a particular store that the developer is monitoring).

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A method for enhancing an interaction with a user based upon information about the current emotive state of the user, the method comprising:
uploading an application to a mobile computerized device of a user whose present and later emotive states are desired for use in enhancing the interaction with the user;
detecting and collecting metric data comprising biometric, geo-spatial and/or activity information about the user by way of one or more sensors associated with or in communication with the mobile computerized device;
using the metric data to make further determinations about the user's emotive state, the user's emotive state comprising one of a plurality of categories of emotive states;
applying pre-determined weights to each metric with respect to one of the plurality of emotive states so that the relevance of the metric data to such emotive state is taken into consideration;
periodically updating each of the weights to reflect changes in the relevance of the metric data to the emotive state to be determined;
determining a value corresponding to each of the emotive states; and
using the emotive state values to enhance interaction with the user.

2. The method of claim 1, wherein the plurality of emotive states comprises affect, stress, anger and alertness, where affect reflects a continuum from happy to sad and alertness comprises a continuum from sleepy to wide awake.

3. The method of claim 1, where the metric data comprises one or more of device use, ambient environment, location, and user physical activity.

4. A method for monitoring and assessing a person's emotive state using information about their social and physical activity, the method comprising:
determining an average baseline of the person's emotive state;
monitoring an actual emotive state of the person through the analysis of metrics associated with the person's social and physical activity;
determining whether there are deviations of the actual emotive state from the average baselines;
predicting a future emotive state based on the average baseline and the actual emotive state; and
seeking to modify the person's environment to compensate for the deviation from the average baseline.
